(19) United States
(12) Patent Application Publication
(10) Pub. No.: US 2025/0178029 A1
(43) Pub. Date: Jun. 5, 2025

(54) ELECTROACOUSTIC TRANSDUCER

(71) Applicant: Richard Wolf GmbH, Knittlingen (DE)

(72) Inventor: Edgar BAUER, Kraichtal (DE)

(21) Appl. No.: 18/842,924

(22) PCT Filed: Feb. 7, 2023
(86) PCT No.: PCT/DE2023/200027

§ 371 Date: Aug. 30, 2024

(30) Foreign Application Priority Data
Mar. 2, 2022 (DE) 10 2022 202 115.0

(51) Int. Cl. B06B 1/06

(52) U.S. Cl. CPC B06B 1/0622; B06B 2201/76

(57) ABSTRACT

The electro-acoustic transducer (1) includes a multitude of piezoelements (2) which are arranged in a holder (3) in recesses (5), in which the piezoelement (2) is positively held in the circumferential direction. Furthermore, a holding structure is provided which positively engage over the piezoelements (2) at their end faces (9) and thus hold these. This formation is then embedded into a curing plastic casting compound (4) after wiring.

### CROSS REFERENCE TO RELATED APPLICATIONS

This application is a United States National Phase Application of International Application PCT/DE2023/200027, filed Feb. 7, 2023, and claims the benefit of priority under 35 U.S.C. § 119 of German Application 10 2022 202 115.0, filed Mar. 2, 2022, the entire contents of which are incorporated herein by reference.

### TECHNICAL FIELD

The present invention pertains to an electro-acoustic transducer.

### BACKGROUND

Electro-acoustic transducers of the aforementioned type in particular are used for the generation of shock waves for medical, but also other applications. Such a transducer consists of a multitude of piezoelements which are arranged next to one another and which are arranged in one more planes, e.g. in a calotte-shaped manner and thus form a self-focusing transducer. Numerous transducer shapes are known, and these focus e.g. in a linear, annular or pointwise manner, or not.

Herein, it is counted as belonging to the state of the art to bond the piezoelements on a metal calotte at the inner side, wherein the metal calotte forms the carrier of the later transducer and simultaneously creates the electrical connection at one side of the piezoelements, whereas a wiring is effected at the other side and the piezoelectric elements are subsequently embedded into a casting compound.

Inasmuch as this is concerned, a construction as belongs to the state of the art from DE 10 2010 055 836 B4 is more favorable. Concerning this so-called carrier-free construction, the so-called carrier serves essentially for assembly purposes, i.e. the mounting of the piezoelements before incorporating the casting compound which forms the actual carrier. Through-holes are provided in the extensive holder (denoted there as the carrier) which receives the piezoelements, and a piezoelement which is clampingly fastened in the through-holes or is positively held on the carrier between two shrink tube sections which are attached to the piezoelement, is inserted into said through-holes.

This arrangement has the disadvantage that the insertion and alignment of the piezoelements within the extensive holder is quite work-intensive. Moreover, the alignment of the piezoelements within the holder can be inaccurate, which is to be avoided.

### SUMMARY

It is an object of the invention to design an electro-acoustic transducer of the known type such that the aforementioned disadvantages are avoided.

According to the invention, this object is achieved by an electro-acoustic transducer with the features of the present invention.

The electro-acoustic transducer according to the invention comprises a multitude of piezoelements which are arranged in one or more holders, wherein recesses or holding elements are provided at the holder side and each circumferentially surround a piezoelement with a positive fit at least in sections. According to the invention, the one or several holders comprise holding means which positively hold the piezoelement on their end faces.

The basic concept of the present invention is to not only positively receive the piezoelements circumferentially by way of the holder or the holders, but beyond this to provide holding means which positively hold the piezoelements at their end faces, in order in this manner to ensure a defined position with respect to the holder and hence a designated positioning within the transducer. Herein, it is particularly favorable to provide the holding means at the holder side since the positioning of the piezoelements is then unambiguously fixed by the holder itself and no further provisions need to be made at the piezoelement side as far as this is concerned. It is therefore exclusively the respective holder which is responsible for the defined arrangement of the piezoelements and herewith piezoelements can be inserted into the holder without any preparation or adaptation. After the insertion of the piezoelements into the holder or the holders, the electrical contacting of the contacts at the end faces is then effected, for example by way of soldering with suitable connection wires, whereupon the casting into a self-supporting typically (carrier-free) transducer can then be effected. The holder or holders herein serve first and foremost for the fixation of the piezoelements during the manufacture.

According to a further development of the invention, it is particularly advantageous if the holding means comprise arms which engage over the end faces of the piezoelements, preferably with a positive fit. Herein, each holding means comprises at least one such holding arm. These holding arms are particularly favorable since given a suitably slim and elastic design they permit the insertion of the piezoelements into the respective holder in a simple manner, but after this procedure simultaneously however positively fix the respective piezoelement in the holder in all directions and specifically in a defined position. These holding arms moreover not only leave sufficient free space on installation, but also on electrical connection, e.g. on soldering the connection wires at the end faces.

In an advantageous embodiment of the invention, at least one holding arm pair is provided for a piezoelement, with an arm which engages over the face-side end and with another arm which engages over the other face-side end. Such a holding arm pair is advantageously arranged parallel to the longitudinal axis of a piezoelement. If the holder is an essentially extensive element, in which recesses are provided or in which holding elements are provided, then these holding arms advantageously run essentially perpendicular to the extensive holder or to the holding elements which form these. Advantageously, the holding arms of a holding arm pair are flush with one another but they can also be arranged offset to one another.

At least one of the holding arms of such a pair can also run in a slightly oblique manner, in order to simplify the insertion of the piezoelement into the holder. Herein, according to an advantageous further development, at least one of the holding arms of the holding arm pair is designed in a spring-elastic manner, so that for the insertion of the piezoelement into the holder it can yield laterally outwards and tensioned such that the piezoelement can be freely inserted into the recess of the holder or into the holding element of the holder in the direction of the longitudinal axis of the piezoelement. Herein, the piezoelement is advanced to such an extent until the one end face of the piezoelement axially bears on the end of an arm of the holding arm pair with a positive fit and the other holding arm then after insertion of the piezoelement due to its springing back gets into its original position, in which its end positively engages over the other end face of the piezoelement and the piezoelement is therefore positively fixed in the holder in all directions.

In order to bring a piezoelement into the holder by way of simple axial insertion and to simultaneously fix it in this with a positive fit, it is advantageous if the holding arm which is designed in a spring-elastic manner comprises an oblique run-on surface on its part which engages over the face-side end of the piezoelement. If the piezoelement is then axially inserted into the holder in a manner aligned to the recess in the holder or to the holding element in the holder, then on account of this oblique run-on surface, the engaging-over part of the holding arm on axial insertion is displaced outwards with respect to the recess in a spring-elastic manner until the piezoelement is arranged in the holder in the designated position, whereupon the holding arm springs back and the face-side end of the holding arm engages over the piezoelement and hence also fixes it in the axial direction. In particular, such an arrangement is particularly advantageous for an equipping by machine but also for a simple manual equipping.

Expediently, a piezoelement is fixed in the holder with two or more, preferably three holding arm pairs which are uniformly distributed over the periphery. Such an arrangement on the one hand permits a simple axial insertion of the piezoelectric element into the holder and on the other hand guarantees an exactly fitting fixation within the holder as well as a free accessibility of the end faces for contacting.

Advantageously, a piezoelement is circumferentially coated with an insulating tube, preferably a shrink tube. Such an insulating tube increases the dielectric strength and in contrast to the state of the art can be attached and fixed on the piezoelement before the assembly of the piezoelement in the holder.

Advantageously, piezoelements of a cylindrical shape are applied, thus those which have a circular cross section. However, piezoelements with a polygonal cross section can also be applied, wherein the end faces should preferably be plane and arranged transversely to the longitudinal axis.

The holder or holders are advantageously designed as plastic components. In particular, it is advantageous to manufacture these components with 3D printing on manufacture of smaller batch numbers. A holder is typically to be understood as an extensive component, in which recesses are provided, said recesses serving for receiving the piezoelements. Alternatively, the holder can be formed by a grid-like, extensive structure, wherein the parts of the grid which surround a piezoelement form a holding element. The holding arms are advantageously also attached to this holding element.

With regard to assembly and connecting technology, it is advantageous if the electrical connections of the piezoelements are located on their end faces. A comparatively high dielectric strength then arises, without the use of an insulating tube as well as further improved by the use of such.

In order to complete the electro-acoustic transducer, the holder or holders with the piezoelements which are incorporated therein are embedded in a curing compound, preferably in plastic. The holder or holders herein also serve for the positioning of the piezoelements to one another, but after curing the surrounding plastic basically no longer have a supporting function. However, in an advantageous further development according to the invention, the holder or holders can form a type of reinforcement for the composite material in the curing compound, by which means the service life of the thus formed electro-acoustic transducer can be improved.

For incorporating the casting compound, the holder or holders which is/are completed by the equipping and wiring with piezoelements is/are arranged in a casting mold which can likewise be formed in a 3D printing method. This casting mold can either be removed after curing the compound, but can also form part of the later transducer. Expediently, the casting mold and the holder are designed and matched to one another such that engaging into one another with a positive fit they can be assembled in the position which they are later to assume after the curing of the mass.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of a holder with piezoelements which are arranged therein, in a sectioned representation;

FIG. 2 is a view of the arrangement of the finished equipped holder section within the electro-acoustic transducer, in a sectioned representation,

FIG. 3 is an enlarged plan view of an alternative arrangement of holding arm pairs; and

FIG. 4 is a view of a preferred design of a holding arm pair on the carrier in a representation according to FIG. 1.

### DESCRIPTION OF PREFERRED EMBODIMENTS

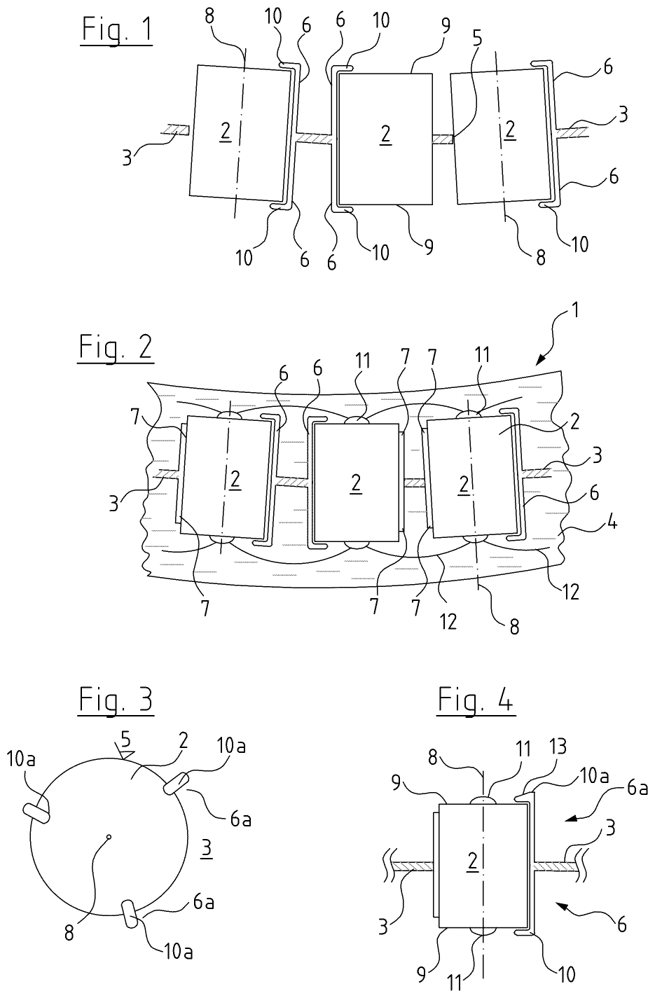

Referring to the drawings, FIG. 2 shows a section of a self-supporting transducer calotte of a piezoelectric shock wave source, as is described in DE 10 2010 055 836 B4, the entire contents of which is hereby incorporated by reference, by way of FIG. 1 or 5. Herein, it is a self-focusing electro-acoustic transducer 1 which is constructed of a multitude of piezoelements 2 which are arranged in a holder 3 and are connected by way of a curing casting compound 4 into a self-supporting formation. In the represented embodiment, the piezoelements 2 have a cylindrical shape and are arranged in recesses 5 of the extensive holder 3 which is formed essentially transversely to the longitudinal axes 8 of the piezoelements 2. The holder 3 follows the calotte shape, so that all piezoelements 2 are arranged at the same distance to a focus which is not visible in the drawing.

The holder 3 serves essentially for holding the piezoelements 2 at their designated position before being enveloped by the casting compound 4. The recesses 5 are designed and arranged such that they receive the piezoelements 2 with little play, so that these on the one hand are easily assembled but on the other hand are circumferentially held with a positive fit.

The holder 3 in the region of the recesses 5 comprises holding means and specifically with the embodiment which is represented by way of FIGS. 1 and 2 in the form of holding arm pairs 6,6 and guide arm pairs 7,7. Each arm pair 6,6; 7,7 extends from the perimeter of a recess 5 to a side of the extensive holder 3 essentially in a direction parallel to the longitudinal axis 8 of a piezoelement 2. Herein, the guide arms 7 only extend up to the proximity of the end faces of the piezoelements 2, and a guide arm pair 7,7 is herewith shorter than the extension of a piezoelement 2 in the direction of its longitudinal axis 8. The holding arm pairs 6,6 in contrast extend beyond the end faces 9 of a piezoelement 2 and with their ends 10 engage over the end faces of a piezoelement 2 and herewith positively fix this on the holder 3 in the axial direction.

Each holding arm 6 at its free end is designed such that it projects somewhat beyond the end face 9 of the associated piezoelement 2 and herewith positively holds the piezoelement 2 in the axial direction. Herein, a holding arm 6 is designed such that with respect to the associated piezoelement 2 can spring out radially with its end 10 in a manner such that a piezoelement 2 can be led past this end 10, inserted through the recess 5 and advanced so far until it bears on the end 10 of the oppositely lying holding arm 6. An automatic restoring of the other holding arm 6 which is caused by spring force is then effected, so that the piezoelement 2 is positively held in the axial direction by the two ends 10 of the holding arm pair 6,6.

Basically, the arrangement of a holding arm pair 6,6 on a recess 5 or a suitable circumferential holding element of the holder 3 is sufficient in order to ensure a defined position of the piezoelement 2 with respect to the holder 3. Expediently, at least one guide arm pair 7,7 or a further holding arm pair 6,6 is to be provided.

Concerning the embodiment according to FIG. 3, three holding arm pairs 6, 6a are provided and these are arranged distributed symmetrically about the recess 5 and each with their ends 10 and 10a engage over the end faces 9 of the piezoelement 2. This design permits a reliable positioning and further ensures that the face-side contacts 11 can be accessible and thus connected to the connection wires 12 by way of soldering without any problem, said connection wires being manufactured after incorporating the piezoelements 2 into the recesses 55 of the holder 3, before the casing compound 4 encloses the formation.

A holding arm pair 6, 6a of FIG. 3 is represented in a lateral view by way of FIG. 4, concerning which on an end (which is at the top in FIG. 4) of the holding arm 6a, the end 10a is provided with a run-on surface 13 which runs obliquely to the longitudinal axis of the holding arm 6 and which is arranged such that on introducing a piezoelement 2 this hits the run-on surface 13 and given a further displacement in the direction of its longitudinal axis 8 presses this run-on surface 13 radially outwards, i.e. resiliently outwardly impinges the holding arm 6a.

Hence no particular manipulation is required for springing out the holding arm 6a on introducing the piezoelement 2, but this is effected automatically by way of the advance force of the piezoelement 2 in the direction of its longitudinal axis 8, just as this end 10a springs out again after passage of the piezoelement 2 and herewith the piezoelement 2 is positively held between the ends 10 and 10a.

In order, on inserting the piezoelement into the holder 3, for no transverse forces to be exerted upon the piezoelement, it is advantageous to arrange these holding arms 6a with the run-on surfaces 13 at their ends 10a in a point-symmetric manner about the axis 8, as is represented by way of FIG. 3.

While specific embodiments of the invention have been shown and described in detail to illustrate the application of the principles of the invention, it will be understood that the invention may be embodied otherwise without departing from such principles.

### LIST OF REFERENCE NUMERALS

1 electro-acoustic transducer
2 piezoelements
3 holder
4 casting compound
5 recesses
6 holding arm
6a holding arm with run-on surface
6,6 holding arm pair
7 guide arm
7,7 guide arm pair
8 longitudinal axis of 2
9 end faces of 2
10 end of 6
10a end of 6a
11 contacts
12 wires
13 run-on surface

1. An electro-acoustic transducer comprising:
one or more holders; and
a multitude of piezoelements which are arranged in the one or more holders, wherein recesses or holding elements are provided in one of the one or more holders or several holders and each circumferentially surround one of the piezoelements with a positive fit at least in sections, wherein the one or several holders comprise holding means which positively hold the one of the piezoelements on end faces thereof.

2. An electro-acoustic transducer according to claim 1, wherein the holding means comprises holding arms which engage over the end faces of the piezoelements with a positive fit.

3. An electro-acoustic transducer according to claim 2, wherein at least one holding arm pair is provided each for one piezoelement, with an arm which engages over one face-side end and with another arm which engages over another face-side end.

4. An electro-acoustic transducer according to claim 3, wherein at least one of the one holding arm and the another holding arm of the at least one holding arm pair is designed in a spring-elastic manner such that on inserting the one of the piezoelements into the holder, a part of the one holding arm and the another holding arm which engages over the face-side end can be resiliently pivoted out.

5. An electro-acoustic transducer according to claim 4, wherein the one holding arm and the another holding arm which is designed in the spring-elastic manner comprises an oblique run-on surface on its part which engages over the face-side end of the one of the piezoelements.

6. An electro-acoustic transducer according to claim 3, wherein the one of the piezoelements is fixed in the holder with the at least one holding arm pair and another holding arm pair.

7. An electro-acoustic transducer according to claim 1, wherein the piezoelements are circumferentially coated with an insulating tube.

8. An electro-acoustic transducer according to claim 1, wherein the piezoelements have a circular or polygonal cross section.

9. An electro-acoustic transducer according to claim 1, wherein the one of the one of the one or more holders and the several holders are formed by a plastic component which is manufactured in 3D printing.

10. An electro-acoustic transducer according to claim 1, wherein the piezoelements are electrically connected at at least one of the end faces.

11. An electro-acoustic transducer according to claim 1, wherein the one of the one or more holders and the several holders with the piezoelements arranged therein are embedded in a curing compound.

12. An electro-acoustic transducer according to claim 6, wherein the piezoelement is fixed in the holder with yet another holding arm pair.

13. An electro-acoustic transducer according to claim 1, wherein the piezoelements are circumferentially coated with a shrink tube.

14. An electro-acoustic transducer according to claim 1, wherein the piezoelements have a circular or polygonal cross section and plane end faces which are arranged transversely to a longitudinal axis of the piezoelements.

15. An electro-acoustic transducer according to claim 1, wherein the one of the one or more holders and the several holders with the piezoelements arranged therein are embedded in plastic.

16. An electro-acoustic transducer, comprising:
a plurality of piezoelements; and
a holder, wherein at least the plurality of piezoelements are arranged in the holder, the holder comprising one of recesses and holding elements, each of the one of recesses and holding elements being configured to circumferentially surround one of the piezoelements with a positive fit at least in sections, the holder further comprising a holding means holding one end face of the one of the piezoelements via a positive fit connection.
